(19) United States
(12) Patent Application Publication
(10) Pub. No.: US 2008/0106032 A1
(43) Pub. Date: May 8, 2008

(54) Image forming system and intermediate conveyance unit

(75) Inventor: Takanori Kanda, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 11/906,659

(22) Filed: Oct. 3, 2007

(30) Foreign Application Priority Data
Nov. 8, 2006 (JP) JP2006-302586

(51) Int. Cl. B65H 29/00; B42B 2/00; B65H 45/04

(52) U.S. Cl. 271/279; 270/32; 270/58.07; 270/58.08

(57) ABSTRACT

An image forming system, including an image forming apparatus to form an image on a sheet, a post-finishing apparatus to conduct a post-finishing operation on the sheet carrying the formed image, an intermediate conveyance unit, provided between the image forming apparatus and the post-finishing apparatus, to convey the sheet ejected from the image forming apparatus to the post-finishing apparatus, wherein the intermediate conveyance unit includes a first conveyance route which receives the sheet one by one from the image forming apparatus and ejects the sheet one by one to the post-finishing apparatus, a second conveyance route which receives the sheet one by one from the image forming apparatus and overlaps the sheets as a set of plural sheets to be ejected to the post processing apparatus, and a control section which selects either the first conveyance route or the second conveyance route based on an image forming condition.

This application is based on Japanese Patent Application No. 2006-302586 filed on 08 Nov. 2006 with the Japanese Patent Office, the entire content of which is hereby incorporated by reference.

### FIELD OF THE INVENTION

The present invention relates to an image forming system which includes an image forming apparatus and a post-finishing apparatus which conducts processes onto a sheet carrying a formed image, and to an intermediate conveyance unit which serves as a structuring element of the image forming system.

### BACKGROUND OF THE INVENTION

The post-finishing apparatus, having various post-finishing functions is connected onto the image forming apparatus to form images on recording sheets at high speed, such as an image forming apparatus employing an electro-photographic method, whereby the image forming system satisfies various image reproduction needs.

### SUMMARY OF THE INVENTION

In Unexamined Japanese Patent Application Publication No. 2002-128,384, an image forming system is disclosed in which an image forming apparatus is connected to a post-finishing apparatus carrying a hole punching function, a sheet folding function and a book binding function.

In Unexamined Japanese Patent Application Publication No. 2005-15,225, an image forming system is disclosed in which a common single sheet processing apparatus is arranged between an image forming apparatus and at least one of plural post-finishing apparatuses.

In the case of the image forming system of Unexamined Japanese Patent Application Publication No. 2002-128,384, since various types of post-finishing functions are conducted in a single post-finishing apparatus, it is more effective if the system is installed in an office, for example, in which various users use the system in various usages. Further, said post-finishing apparatus is relatively small that it is very effective for offices which require reduced office space.

On the other hand, in image forming systems, such as for short-run printing, it is not necessary for the image forming system to provide various kinds of post-finishing functions, but may provide only some specific post-finishing functions, whereby typical printing needs will be satisfied. That is, in typical image forming systems, specific users more frequently use specific post-finishing functions, than the case that various users use the various functions in the office.

In Unexamined Japanese Patent Application Publication No. 2002-128,384, a single post-finishing apparatus, which is relatively small, still features various post-finishing functions to conduct various usages. However, from the view-point of each post-finishing function, they are not adequate enough for functional level. If the image forming apparatus is to be used for an image forming apparatus for short-run printing, the required post-finishing level is higher than that of most office printers, and said required level has not yet been attained.

In recent years, the image forming apparatuses employing the electro-photographic method have been used in the field of the short-run printing. That is, while using the image forming apparatus incorporating said post-finishing apparatus, current book production depends on a print-on-demand capability, in which a specific number of volumes are printed in a necessary time.

Further, common copy preparation, used in conventional printing work, is not needed so that the efficiency of book manufacturing can be increased, as well as reducing cost.

The image forming system, disclosed in Unexamined Japanese Patent Application Publication No. 2005-15,225, can meet the requirement efficiently, in which a single sheet processing apparatus, being one of the several post-finishing apparatuses, is connected to a sheet ejecting section of the image forming apparatus, and at least one of the post-finishing apparatuses, among the plural types of the post-finishing apparatuses, is connected to said single sheet processing apparatus.

The image forming apparatus or the image forming system, including the image forming apparatus or the image forming apparatus connecting post-finishing apparatuses, is required to process a greater number of sheets per unit time. Further, the number of sheets processed by the image forming system tends to be limited by the capacity of the post-finishing apparatus other than the capacity of the image forming apparatus.

That is, in the post-finishing apparatus, there are many cases in which after the sheet is temporarily stopped, processing is conducted on the sheet. Though the conveyance speed is increased in the post-finishing apparatus, the processing number of sheets tends to be less than that of the image forming apparatus, due to this, the processed number of image forming system is limited based on that of the post-finishing apparatus.

Accordingly, it is essential for the image forming system that the processed number of the image forming apparatus is controlled to be equal to the processed number of the post-finishing apparatus, whereby high processing capacity to be exhibited by the image forming apparatus is essentially sacrificed.

In order to overcome this problem, applicants offer an image forming system of JP2005-324,588, in which an intermediate conveyance unit is provided between an image forming apparatus and a post-finishing apparatus, in which two or more sheets, ejected from the image forming apparatus, are overlapped in the intermediate conveyance unit, since said two or more sheets are conveyed as a single unit of plural sheets to the post-finishing apparatus, the image forming apparatus can operate at a higher speed, and the various processes can be conducted in the post-finishing apparatus.

Due to a buffer function conducted by the intermediate conveyance unit, the various post-finishing processes can be conducted in this image forming system, while maintaining the higher capacity of the image forming apparatus.

However, the image forming apparatus does not always conduct image formation at a greatest processing sheets number. For example, the image forming apparatus tends to conduct image formation at a lower processing sheets number on thicker sheets. Further, the post-finishing apparatus tends to change its processing sheets number based on the specific types of post-finishing operations.

There are various processing conditions in the image forming apparatus and the post-finishing apparatus. For some processes, simplification of the conveyance route in the intermediate conveyance unit is more preferable from the view-point of stabilization of sheet conveyance.

### SUMMARY OF THE INVENTION

An object of the present invention is to secure stabilization of sheet conveyance, as well as to conduct the various post-finishing operation at a high speed, like the patent application described above.

The object described above is attained by the structures below.

Structure 1. An image forming system, including, an image forming apparatus, a post-finishing apparatus, an intermediate conveyance unit provided between the image forming apparatus and the post-finishing apparatus, wherein after a sheet is ejected from the image forming apparatus, the sheet is conveyed to the intermediate conveyance unit, and after the sheet is ejected from the intermediate unit, the sheet is conveyed further to the post-finishing apparatus, wherein the intermediate conveyance unit includes a first conveyance route which receives the sheet one by one from the image forming apparatus and ejects the sheet one by one to the post-finishing apparatus, a second conveyance route which receives the sheet one by one from the image forming apparatus and overlaps them as a set of plural sheets to be ejected to the post processing apparatus, and a control section which selects either the first conveyance route or the second conveyance route based on at least a condition in the image forming apparatus.

Structure 2. An intermediate conveyance unit, including, a first conveyance route which receives a sheet one by one from an image forming apparatus and ejects the sheet one by one to the post-finishing apparatus, a second conveyance route which receives the sheet one by one from the image forming apparatus and overlaps them as a set of plural sheets to be ejected to the post processing apparatus, and a control section which selects either the first conveyance route or the second conveyance route based on at least a condition on the image forming apparatus.

### BRIEF DESCRIPTION OF THE DRAWINGS

FIG. 1 is a total structural view of an image forming system relating to an embodiment of the present invention.

FIG. 2 is a cross-sectional front view of an intermediate conveyance unit.

FIG. 3 is an enlarged view of FIG. 1, showing a top section of vertical stacking section B1, straight conveyance section B2 and sheet ejection section B3.

FIG. 4 is a cross-sectional view of a driving structure of a width adjustment plate.

FIGS. 5(a) and 5(b) are each a cross-sectional view showing a sheet conveyance process of the intermediate conveyance route.

FIGS. 6(a) and 6(b) are each a cross-sectional view showing a sheet conveyance process of the intermediate conveyance route.

FIGS. 7(a) and 7(b) are each a cross-sectional view showing a sheet conveyance process on the intermediate conveyance route.

FIGS. 8(a) and 8(b) are each a cross-sectional view showing a sheet conveyance process on the intermediate conveyance route.

FIG. 9 shows a driving system of the intermediate conveyance unit.

FIG. 10 is a block diagram of a control system in the image forming system of the embodiment of the present invention.

FIG. 11 is a total structural view of a hole punching—sheet folding apparatus.

FIGS. 12(a)-12(h) show a hole punching process and various kinds of sheet folding processes.

FIG. 13 is a total structural view of a side-stitch binding machine.

FIG. 14 is a schematic view showing a center folding process and sheet conveyance of a saddle-stitching process conducted by a saddle-stitch binding machine.

FIG. 15 is a cross-sectional front view of a large-capacity sheet stacker.

FIG. 16 is a cross-sectional front view of a sheet casing-in machine.

FIG. 17(a) is a perspective view of a sheet bundle which is adhered on a coversheet, and

FIG. 17(b) is a perspective view of a booklet which is produced of the sheet bundle covered with the coversheet.

FIG. 18 is a conceptual diagram of the image forming system.

FIGS. 19(a)-19(e) show various image forming systems.

FIGS. 20(a)-20(d) show various image forming systems.

### DETAILED DESCRIPTION OF THE INVENTION

The present invention will be detailed based on the embodiments of the present invention, however the present invention is not limited to said embodiments.

### [Image Forming Apparatus]

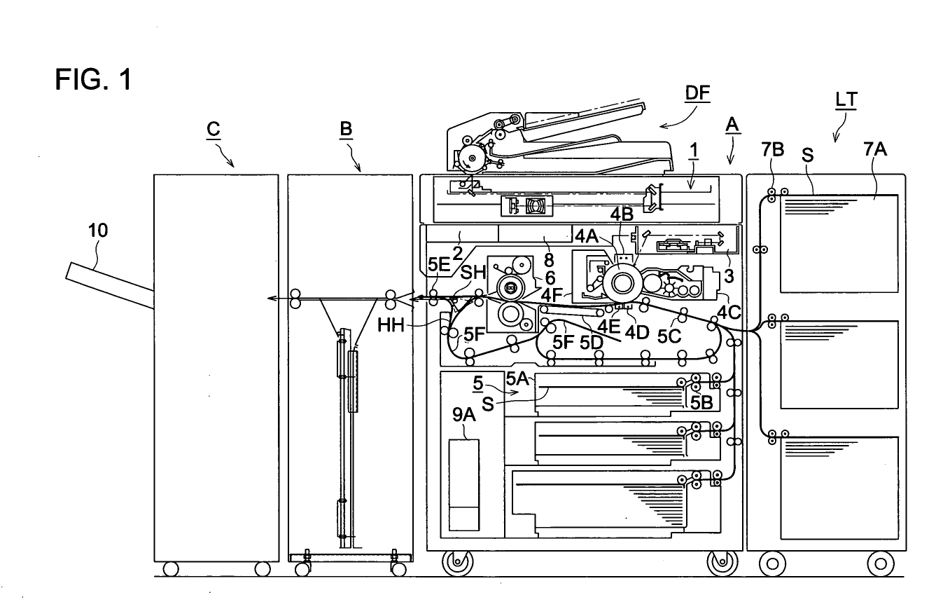

FIG. 1 is a total structural view of the image forming apparatus relating to the embodiments of the present invention, including image forming apparatus A, intermediate conveyance unit B and post-finishing apparatus C.

Image forming apparatus A includes automatic document feeding apparatus DF and large capacity sheets supplying apparatus LT, both are removable structures, image reading section 1, image processing section 2, image writing section 3, image forming section 4, sheet conveyance section 5 and fixing section 6.

Image forming section 4 is structured of photoconductive drum 4A, electric charging section 4B, developing section 4C, image transfer section 4D, sheet separating section 4E, and cleaning section 4F.

Sheet conveyance section 5 includes sheet supplying cassette 5A, first sheet supplying section 5B, second sheet supplying section 5C, sheet conveyance section 5D, sheet ejection section 5E, and sheet re-supplying section (ADU) 5F, which re-supplies sheet S carrying an image on its front surface to image forming section 4, to form an image on the reverse surface of sheet S, in a double surface printing mode.

Operation displaying section 8, which is structured of an input section and a display section, is mounted on a part of the front side on image forming apparatus A.

Intermediate conveyance unit B is connected to sheet ejection section 5E which is shown at the left side of image forming apparatus A in FIG. 1, while post-finishing apparatus C is connected to the left side of intermediate conveyance unit B in FIG. 1.

Images, carried on a single surface or both surfaces of a document sheet placed on a document table of automatic document feeding apparatus DF, are read by an optical system of image reading section 1. The read images are then converted to analog signals, which are processed via an analog process, an A/D conversion, a shading correction, and image compression in image processing section 2, after which the processed signals are sent to image writing section 3.

In image reading section 3, light rays emitted from a semiconductor laser are radiated onto photoconductor drum 4A of image forming section 4 so that latent images are formed. Image forming section 4 conducts various processes, such as electrical charging, exposure, development, image transferring, sheet separation and cleaning of drum 4A.

The images are transferred by image transferring section 4D onto sheet S, supplied by first sheet supplying section 5B. After the fixing process by fixing device 6 is conducted on sheet S carrying the image, said sheet S is conveyed to intermediate conveyance unit B through sheet ejection section 5E. Alternatively, sheet S, carrying the fixed image on its front surface, is conveyed to sheet re-supplying section 5F, whereby images are formed on the reverse surface of sheet S by image forming section 4, then sheet S, carrying the fixed images on both surfaces, is conveyed to intermediate conveyance unit B by sheet ejection section 5E.

Sheet ejection section 5E includes straight ejection route SH which straightly and horizontally conveys sheet S ejected from fixing device 6 and ejects sheet S, and also includes sheet reversing-ejection route HH which reverses sheet S ejected from fixing device 6 and ejects reversed sheet S. Sheet reversing-ejection route HH is structured of a sheet introduction section of sheet re-supplying section 5F and a switch-back path which switches back sheet S from sheet re-supplying section 5F to sheet ejection section 5E.

Large-capacity sheet supplying apparatus LT is structured of sheet stacking section 7A and first sheet supplying section 7B, which continuously supplies a large number of sheets S to image forming apparatus A.

In addition, large-capacity sheet supplying apparatus LT, storing a large number of sheets S carrying printed images, may be connected to intermediate conveyance unit B, whereby said sheet S can be directly conveyed to intermediate conveyance unit B.

### [Intermediate Conveyance Unit]

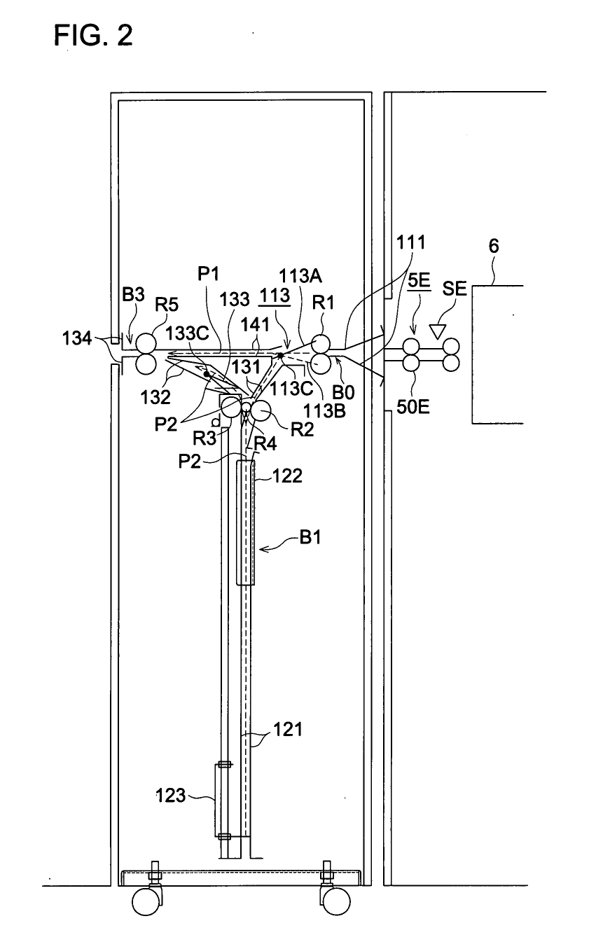

FIG. 2 is a cross-sectional front view of intermediate conveyance unit B.

Intermediate conveyance unit B includes sheet carry-in section B0 to receive individual sheets S ejected from image forming apparatus A, vertical stacking section B1 to stack plural sheets S, straight conveyance section B2 having first conveyance path P1 to straightly convey sheet S in a horizontal direction, and sheet ejection section B3 to eject sheet S to post-finishing section C.

Sheet carry-in section B0 includes angled paired guide plates 111 and also paired conveyance rollers R1. Vertical stacking section B1 includes slanted paired guide plates 131 to downwardly guide sheet S conveyed from carry-in section B0, conveyance rollers R2, R4 and R3, vertical paired guide plates 121 to stack sheets S therein, and slanted paired guide plates 132 to guide sheet S upwardly toward the left for ejection. Sheet ejection section B3 includes paired conveyance roller R5 and paired guide plates 134. In straight conveyance section B2, first conveyance path P1 is formed of horizontally paired guide plates 141 which are vertically disposed. Further, second conveyance path P2 is formed of slanted paired guide plates 131, vertical paired guide plates 121 to stack sheets S, and slanted paired guide plates 132 to guide sheet S upwardly toward the left for ejection.

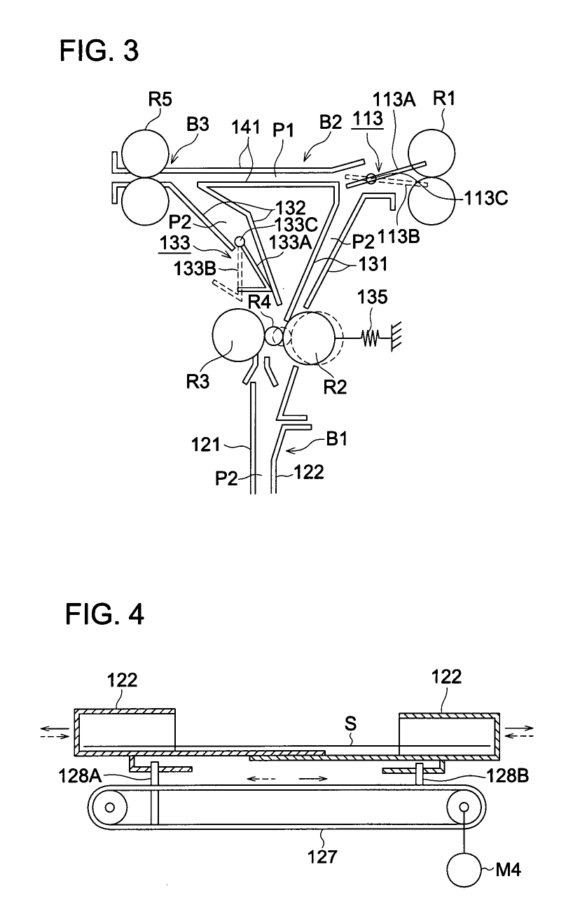

In FIG. 3, the top section of vertical stacking section B1, straight conveyance section B2 and sheet ejection section B3 are enlarged. Numeral 113 represents a switching gate to open a selected conveyance route. The switching gate rotates on shaft 113C to set the gate at position 113A, shown by solid lines, or position 113B, shown by dashed lines, that is, switching gate 113 opens a conveyance route to first conveyance path P1 or second conveyance path P2. Numeral 133 represents a vertical alignment member to align the top end of sheet S, that is, vertical alignment member 133 rotates on shaft 133C to set the gate at position 133A, shown by solid lines, or position 133B, shown by dashed lines. At position 133A, when the leading top of sheet S enters the conveyance route, vertical alignment member 133 aligns sheet S, then vertical alignment member 133 retracts to the position shown by dashed lines, whereby sheet S can advance toward the upper left.

Paired conveyance rollers R1 are mounted on sheet carry-in section B0, driven roller R4 as well as conveyance rollers R2 and R3, are mounted on vertical stacking section B1, and paired sheet ejection rollers R5 are mounted on sheet ejection section B3.

As shown in FIG. 3, driven roller R4 can be changed its position between the solid line position and the dashed line position. Conveyance roller R2 is placed in pressure-contact with driven roller R4 by extension spring 135, whereby conveyance roller R2 changes its position between a solid line position and a dashed line position, based on the position of driven roller R4.

FIG. 4 is a cross-sectional view of the driving structure of width alignment plates 122.

Width alignment plates 122, which are paired at right-and-left positions, are locked by pins 128A and 128B which are mounted on belt 127 rotated by motor M4, that is, width alignment plates 122 move with pins 128A and 128B on belt 127 so that width alignment plates 122 can align sheet S in the width direction, being perpendicular to the sheet conveyance direction.

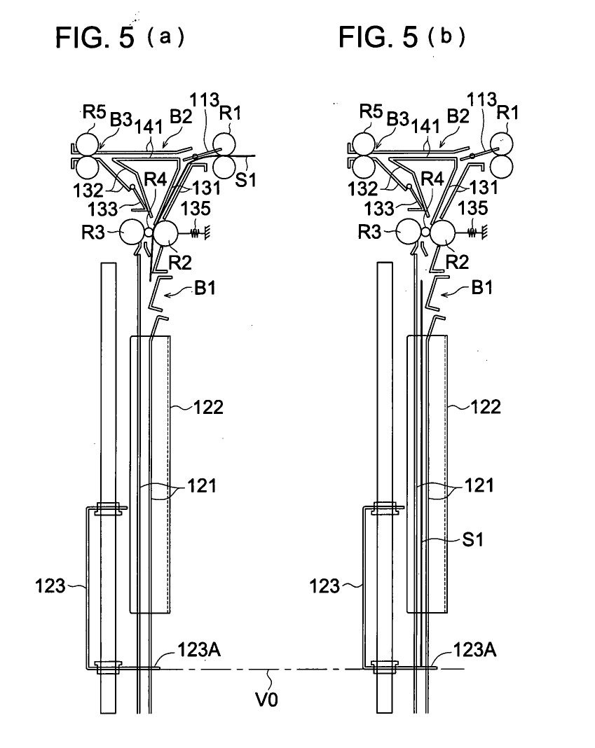

FIGS. 5-8 show various conditions of stacking and alignment of sheets S on vertical stacking section B1, and show the operation of intermediate unit B during the sheet conveyance from vertical stacking section B1 to sheet ejection section B3.

(1) Switching gate 113 is set at position 113A in FIG. 5(a), while conveyance roller R2 and driven roller R4 are positioned at the solid line positions in FIG. 3.

Conveyance rollers R1 and R2 rotate at the same line speed with that of sheet ejection rollers 50E of sheet ejection section 5E of image forming apparatus A in FIG. 2. First sheet S, nipped by conveyance rollers R1 and R2, is guided by switching gate 113 to vertical stacking section B1, and conveyed downward.

(2) In FIG. 5(b), the leading top edge (which is the lower edge) of first sheet S1 falling by its own weight, having been conveyed to vertical stacking section B1, is stopped by horizontal stopper 123A of supporting member 123.

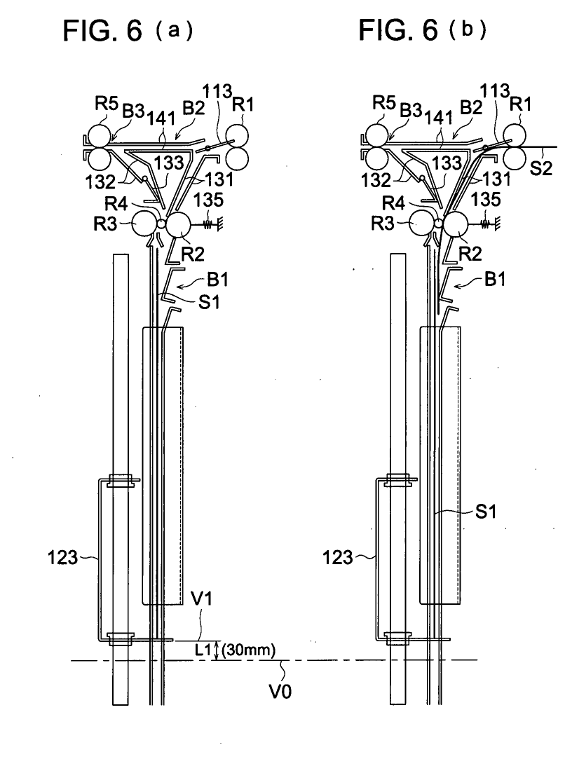

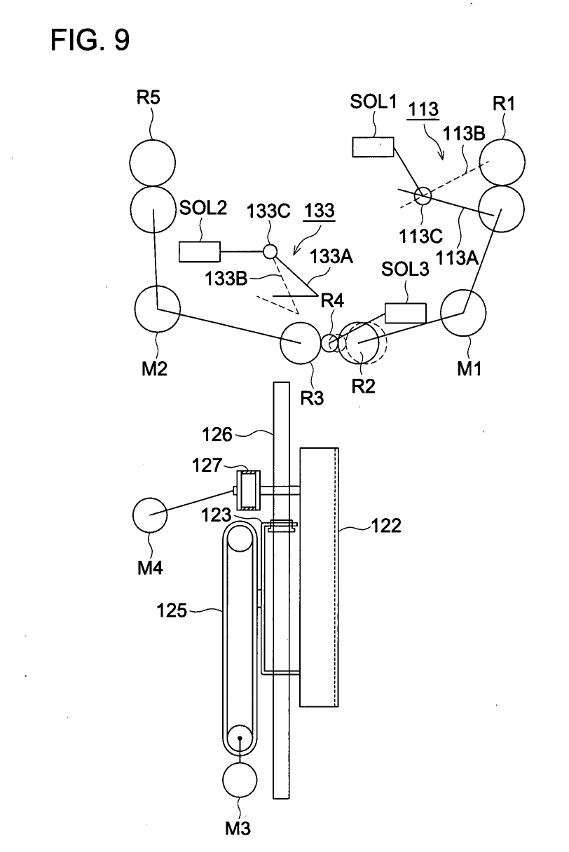

(3) In FIG. 6(a), stopper 123A of supporting member 123 is shifted from initial position V0 to first position V1 at predetermined distance L1 (30 mm, for example) higher than initial position V0, by motor M3 (which will be detailed later in FIG. 9).

(4) In FIG. 6(b), second sheet S2 is conveyed by conveyance rollers R1 and R2 to vertical stacking section B1. When second sheet S2 is carried in, supporting member 123 moves upward as shown in FIG. 6(a), and thereby, the top end of first sheet S1 moves upward, accordingly sheet S1 and sheet S2 are prevented from colliding.

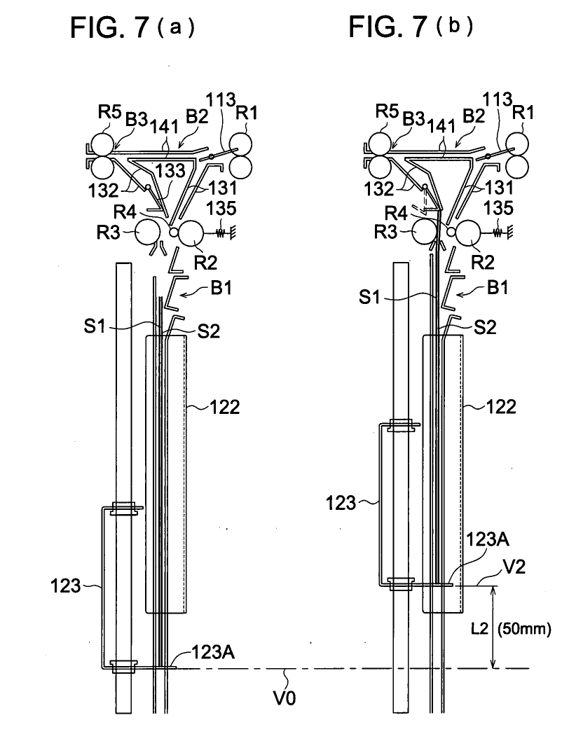

(5) In FIG. 7(a), the lower end of second sheet S2 reaches stopper 123A, whereby two sheets, being first sheet S1 and second sheet S2, are overlapped in vertical stacking section B1.

Additionally, supporting member 123 has already returned from first position V1 to initial position V0.

Further, driven roller R4 moves to the right so that a clearance is formed between conveyance roller R3 and driven roller R4. Conveyance roller R2 is pushed by driven roller R4, and is shifted to the right.

(6) In FIG. 7(b), supporting member 123 is shifted by motor M3 (which will be detailed later in FIG. 9) from initial position V0 to second position V2 which is predetermined distance L2 (50 mm, for example) higher than initial position V0, being higher than first position V1, whereby the top ends of overlapped sheets S1 and S2 are stopped by vertical alignment member 133, accordingly, sheets S1 and S2 are both aligned in the sheet conveyance direction. The position, where the top ends of both sheet S1 and S2 stop, is more downstream of the sheet conveyance direction than conveyance roller R3, that is, the position is higher than conveyance roller R3. At the same time to the vertical alignment, or after the vertical alignment is completed, width alignment plates 122 are shifted by motor M4 (see FIGS. 4 and 9), so that the side edges of sheet S1 and sheet S2 are pushed in the sheet width direction, that is, a width directional alignment is completed.

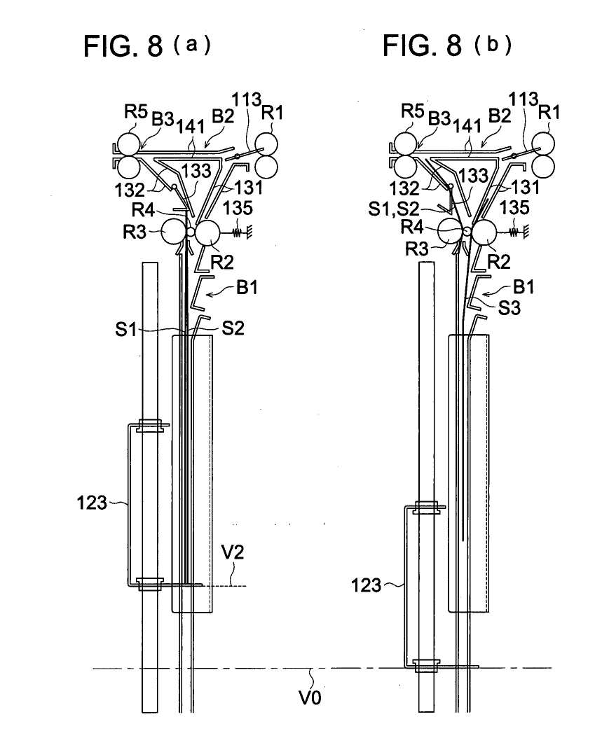

(7) In FIG. 8(a), driven roller R4 is shifted toward the left so as to be in pressure-contact with conveyance roller R3, whereby sheets S1 and S2 are nipped between conveyance roller R3 and driven roller R4. Conveyance roller R2 is shifted to the left following driven roller R4.

Based on the above procedure, a state has been prepared for introducing a next sheet into vertical stacking section B1.

(8) In FIG. 8(b), supporting member 123 is lowered so that stopper 123A reaches position V0, designated as the initial position, and vertical alignment member 133 is returned to a retracted position, whereby sheet passage can be conducted.

After vertical alignment member 133 is retracted, conveyance roller R3 and paired conveyance rollers R5 rotate to eject sheets S1 and S2.

Further, simultaneously with the ejection of sheets S1 and S2, third sheet S3 is carried in vertical stacking section B1 by paired conveyance rollers R1 and conveyance roller R2.

By the completion of the ejection of sheets S1 and S2, vertical alignment member 133 returns to the position shown by the solid line, that is, a state shown in FIG. 5(a) exists.

When sheet conveyance is to be conducted by straight conveyance section B2, instead of vertical stacking section B1, switching gate 113 moves to a position shown by numeral 113B in FIG. 3, and guides sheet S to straight sheet ejection section B3.

In the mode in which sheet S is carried into vertical stacking section B1, and then ejected, it is possible to eject sheet S one by one without stacking sheet S, or further possible is to stack more than three sheets S and then eject them as a unit.

As detailed while referring to FIGS. 5-8, sheet S is reversed when vertical stacking section B1 is used.

Sheet S is not reversed in the conveyance mode in which straight conveyance section B2 is used, that is, sheet S, ejected one by one from image forming apparatus A, is conveyed one by one to post-finishing section C.

The maximum conveyance speed of sheet ejection roller 50E (see FIG. 2) of image forming apparatus A is 570 mm/sec, while the conveyance speed of the sheet in post-finishing apparatus C is 1,000 mm/sec.

In the conveyance mode using straight conveyance section B2, until sensor SE, mounted on sheet ejection section 5E of image forming apparatus A, detects a trailing edge of sheet S, paired conveyance rollers R1 and paired ejection rollers R5 convey sheet S at 570 mm/sec, which is the sheet conveyance speed of image forming apparatus A. When the trailing edge of sheet S1 is detected by sensor SE, the sheet conveyance speed of paired conveyance rollers R1 and paired ejection rollers R5 is switched to 1,000 mm/min. Paired sheet ejection rollers R50E of image forming apparatus A include a one-way clutch, which are driven by sheet S conveyed at 1,000 mm/sec.

FIG. 9 shows the driving system of intermediate conveyance unit B.

Symbol SOL1 represents a solenoid which switches switching gate 113 to either position 113A shown by a solid line, or position 113B shown by dashed lines. Symbol SOL2 represents a solenoid which switches vertical alignment member 133 to either position 133A shown by a solid line or position 133B shown by dashed lines. Symbol SOL3 represents a solenoid which shifts driven roller R4. Symbol M1 represents a motor which rotates conveyance rollers R1 and R2. Symbol M2 represents a motor which rotates conveyance roller R3 and sheet ejection roller R5. Symbol M3 represents a motor which drives supporting member 123 vertically. Symbol M4 represents a motor which drives width alignment plates 122 horizontally.

Supporting member 123, whose horizontal section, provided in its lower end, forms a supporting surface for sheet S, is attached to belt 125 which is driven by motor M3, whereby supporting member 123 is driven vertically by motor M3 while being guided by vertical guide bar 126.

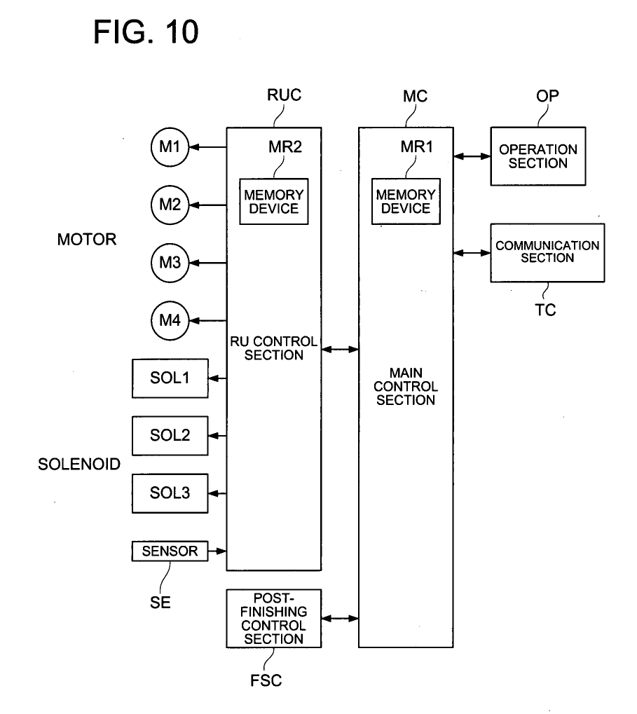

FIG. 10 shows a block diagram of the control system of sheet conveyance control of the image forming system.

A control section which controls a total image forming system is structured of main control section MC to control image forming apparatus A, RU control section RUC which controls sheet conveyance in intermediate conveyance unit B, and post-finishing control section FSC which controls post-finishing apparatus C, whereby all control sections work together to conduct various control functions.

Main control section MC, to which operation section OP and communication section TC are connected, obtains setting information inputted by the operator via operating section OP or communication section TC, and sends various information concerning the state of the image forming system to operation section OP and communication section TC.

As will be detailed later, main control section MC includes memory device MR1, storing a reference table, which is used when either straight sheet ejection or reversed sheet ejection is selected. RU control section RUC includes memory device MR2, storing a different reference table, which is used when either the first conveyance route or the second conveyance route is selected.

Additionally, memory device MR2, storing the reference table, can be included in main control section MC.

Sheet conveyance from image forming apparatus A to post-finishing apparatus C through intermediate conveyance unit B is conducted as below.

The sheet conveyance speed in image forming apparatus A is fundamentally 570 mm/sec, as the maximum sheet conveyance speed, but which can be set, for example, at 490 mm/sec, being lower than the maximum sheet conveyance speed, based on the type or thickness of sheet S.

The sheet conveyance speed in post-finishing apparatus is greater than that in image forming apparatus A, for example, 1,000 mm/sec.

When intermediate conveyance unit B has received sheet S from image forming apparatus A, intermediate conveyance unit B conveys sheet S at the same speed as the sheet conveyance speed in image forming apparatus A, and when the trailing edge of sheet S is separated from image forming apparatus A, intermediate conveyance unit B increases its sheet conveyance speed to that of post-finishing apparatus C, and further conveys sheet S.

The sheet conveyance speed in intermediate conveyance apparatus B is switched, based on a signal indicating that the trailing edge of sheet S has been detected by sensor SE, mounted on sheet ejection section 5E (see FIG. 2) of image forming apparatus A.

Sheet ejection roller 50E, mounted on sheet ejection section 5E of image forming apparatus A, includes a one-way clutch, whereby when the sheet conveyance speed is increased in intermediate conveyance unit B, sheet ejection roller 50E is driven by the movement of sheet S.

Accordingly, the sheet conveyance speed in post-finishing apparatus C is greater than that in image forming apparatus A. However, since post-finishing apparatus C conducts various post-finishing processes while the sheet conveyance is stopped, the number of sheets finished by post-finishing apparatus C is less than the maximum number of sheets formed by image forming apparatus A, from the view-point of the number of sheets processed during a unit time, which will be shown as 100 sheets per minute, for example.

That is, when symbol N1 represents the maximum number of sheets formed by image forming apparatus A, and symbol n2 represents the number of sheets finished in post-finishing apparatus C, and when image forming apparatus A works at the greatest operating efficiency, the image forming system operates under the relationship of N1>N2.

When straight ejection route SH is used, the sheet ejection speed of image forming apparatus A is 570 mm/sec, for example, which is the same as the image forming speed of image forming apparatus A, while when sheet reversing-ejection route HH is used, a greater sheet ejection speed, being 1,250 mm/sec is set so that the delay of sheet ejection timing due to reversing-sheet ejection is decreased.

Further, as will be detailed later, when image forming apparatus A is operated at lower efficiency due to lower quality of the sheets being used, and when the number of sheets formed during a unit time by image forming apparatus A is shown by N3, the image forming system operates under the relationship of N3=N2.

Due to the above described operation of the image forming system, greater performance of the image forming apparatus is effectively utilized, and thereby the various post-finishing functions will be carried out.

The various operations of the image forming system will be detailed below.

Image forming apparatus A conducts image formation while changing the sheet conveyance speed, based on the image forming conditions, such as the thickness of sheet, that is, basis weight of sheet, and the type of sheets.

As described above, since the number of sheets finished in the post-finishing apparatus C is less than the maximum number of sheets formed in image forming apparatus A, if the sheet is conveyed in image forming apparatus A at the sheet conveyance speed corresponding to the number of sheets which is less than the number of sheets to be finished in the post-finishing apparatus C, and the sheet is then sent to post-finishing apparatus C, there is no problem. However, if the sheet is conveyed in image forming apparatus A at the sheet conveyance speed corresponding to the number of sheets which is greater than the number of sheets finished in the post-finishing apparatus C, a difference of the number of processed sheets is created between the two apparatuses, whereby the overall system cannot operate, resulting in a major problem.

Intermediate conveyance unit B overcomes this problem. That is, intermediate conveyance unit B temporarily stores the plural sheets ejected from image forming apparatus A, after which the plural sheets are conveyed as one unit. Accordingly, even when there is any difference between the numbers of sheets processed in each apparatus, the image forming system can operate, without interruption.

The difference between the number of sheets processed in each apparatus is overcome by such a method in which the sheets are carried in the sheet stacking section, which stores the plural sheets, after plural sheets are stacked vertically, they are ejected from the sheet stacking section. However, in a mode in which the number of sheets formed in image forming apparatus A is less than the number of sheets finished in post-finishing apparatus C, it is possible for the image forming system to allow the number of sheet formed in image forming apparatus A to be equal to the number of sheets finished in post-finishing apparatus C. In this case, intermediate conveyance unit B does not absorb the difference between both numbers, but the sheets are only conveyed through intermediate conveyance unit B. Accordingly, it is preferable that the conveyance route in intermediate conveyance unit B is as simple and short as possible. Simplification of the conveyance route of intermediate conveyance unit B can reduce the sheet conveyance time as well as the probability of occurring the sheet conveyance errors, resulting in more reliable operation.

In the present invention, when considering working efficiency and stability of the system, in intermediate conveyance unit B, provided are second conveyance path P2 featuring a buffer function conducted by vertical stacking section B1, and first conveyance path P1 having no such buffer function, wherein path P1 or P2 is selected based on the operation conditions.

In the example below, either second conveyance path P2 or first conveyance path P1 is selected. Further, a stacking mode using second conveyance path P2 is structured of a plural-sheet-stacking mode, in which after plural sheets are stacked in vertical stacking section B1, they are ejected, and a mono-sheet-stacking-mode, in which after a single sheet is carried in vertical stacking section B1, it is conveyed.

Listed below are the conditions to select the mode of sheet conveyance in intermediate conveyance unit B.
a. the thickness of sheet
b. the type of sheet
c. the type of post-finishing
d. image formation on a single surface or both surfaces
e. sheet ejection modes (being face-down mode or face-up mode)

### Other than the above conditions, the size of sheet can also be a condition to select the conveyance mode.

Since the sheet conveyance speed in the fixing device of image forming apparatus A varies based on the thickness or the type of sheet, the sheet conveyance speed in image forming apparatus A, which is known as a “processing speed” is set to various values.

When the sheet conveyance speed in image forming apparatus A is set lower, the number of sheets formed in image forming apparatus A will not be greater than the maximum number of sheets finished in post-finishing apparatus C, whereby vertical stacking section B1 of intermediate conveyance unit B is not used.

Based on the type of post-finishing apparatus C, the sheet conveyance speed in post-finishing apparatus C can be various values, therefore, the buffer function conducted in intermediate conveyance unit B, which is a function to absorb the difference between the number of sheets formed by image forming apparatus A and the number of sheets finished by post-finishing apparatus C, can be set so as to agree with the difference between the numbers of sheets to be conducted in each apparatus.

Further, based on whether the sheet ejection mode of post-finishing apparatus C is the face-down mode or the face-up mode, vertical stacking section B1 to reverse the sheet can be selected or not.

The number of sheets to be finished in post-finishing apparatus C in a unit time depends upon the type of post-finishing.

For example, sheet shift process is conducted at a higher finishing number, while multi-folding process is at a lower finishing number. Further, since the multi folding is conducted for a single sheet, the sheet must be conveyed one by one to post-finishing apparatus C. Accordingly, in this case, the sheet conveyance speed in image forming apparatus A is at the highest speed, that is, 570 mm/sec. By increasing the interval between sheets, the number of sheet ejected from image forming apparatus A in a unit time can be set lower, whereby sheet conveyance control is conducted so as to agree with the number of sheets formed by image forming apparatus A with the number of sheets finished by post-finishing apparatus C.

In the case of image formation on both sheet surfaces, the number of sheets ejected from image forming apparatus A in a unit time is approximately half number of image formation on a single surface. Accordingly, in many cases for the image formation on both surfaces, post-finishing apparatus C can finish the total sheets ejected from image forming apparatus A, whereby it is not necessary for intermediate conveyance unit B to absorb the difference between the numbers of sheets processed by both apparatuses.

In the face-down ejection mode, the sheets are ordered in accordance with an order of sheets ejected from image forming apparatus A. This mode is known as the “N-to-1 mode”.

In the face-up ejection mode, the sheets are ordered in accordance with an opposite order of sheets ejected from image forming apparatus A. This mode is known as the “1-to-N mode”.

As described above, the sheet is reversed in second conveyance path P2 of intermediate conveyance unit B, while the sheet is not reversed in first conveyance path P1. Accordingly either second conveyance path P2 or first conveyance path P1 is selected for use based on the combination of the sheet ejection mode (being the face-up mode or the face-down mode) in image forming apparatus A, and the sheet ejection mode in the sheet ejection section of post-finishing apparatus C.

Tables 1-1 and 1-2 table 2 show the relationship between second conveyance path P2 in which the sheet is reversed by the various conditions, and first conveyance path P1 in which the sheet is conveyed horizontally and directly.

TABLE 1-1

| | states | | | | determination | | |
|---|---|---|---|---|---|---|---|
| | | | | type or basis | | sheet reversing | |
| | | post- | | weight of | | process in | sheet reversing |
| No. | *1 | finishing | *2 | sheet | *3 | apparatus A | process in RU |
| 1 | 570 | non post- | face | thin or normal | 570 | *4 | reversal of 2 or 3 |
| | | finishing | down | sheet | | | overlapped sheets |
| 2 | | or sheet | | thick sheet | 570 | *4 | reversal of 2 |
| | | shifting | | | | | overlapped sheets |
| 3 | | | | | | | *5 |
| 4 | | | face up | thin or normal | 1250 | ejection of | reversal of 2 or 3 |
| | | | | sheet | | reversed sheets | overlapped sheets |
| 5 | | | | thick sheet | 1250 | ejection of | reversal of 2 |
| | | | | | | reversed sheets | overlapped sheets |
| 6 | | | | | | | *5 |
| 7 | | | | tab-sheet | 570 | *4 | *4 |
| 8 | | | both | — | 570 | *4 | *4 |
| | | | surfaces | | | | |
| 9 | | side- | face | thin or normal | 570 | *4 | reversal of 2 or 3 |
| | | stitching | down | sheet | | | overlapped sheets |
| 10 | | | | thick sheet | 570 | *4 | reversal of 2 |
| | | | | | | | overlapped sheets |
| 11 | | | | | | | *5 |
| 12 | | hole | face | thin or normal | 570 | *4 | reversal of 2 or 3 |
| | | punching | down | sheet | | | overlapped sheets |
| 13 | | | | thick sheet | 570 | *4 | reversal of 2 |
| | | | | | | | overlapped sheets |
| 14 | | | | | | | *5 |

*1: processing speed (mm/sec)
*2: setting the face of sheet to be ejected
*3: sheet ejection speed of apparatus A (mm/sec)
*4: straight conveyance
*5: reversal of a single sheet

TABLE 1-2

| | | | | | determination | | |
|---|---|---|---|---|---|---|---|
| | states | | | | | sheet reversing | |
| | | post- | | type or basis | | process in | sheet reversing |
| No. | *1 | finishing | *2 | weight of sheet | *3 | apparatus A | process in RU |
| 15 | 570 | multi- | face down | — | 570 | *4 | *5 |
| 16 | | folding | face up | other than the | 1250 | ejection of | *5 |
| | | | | below | | reversed sheets | |
| 17 | | | | tab-sheet | 570 | *4 | *4 |
| 18 | | | | — | 570 | *4 | *4 |
| 19 | | | both | — | 570 | *4 | *4 |
| | | | surfaces | | | | |
| 20 | | saddle- | both | — | 570 | *4 | *4 |
| | | stitching | surfaces | | | | |
| 21 | | center | face down | — | 570 | *4 | *5 |
| 22 | | folding of | both | — | 570 | *4 | *4 |
| | | the | surfaces | | | | |
| | | overlapped | | | | | |
| | | sheets | | | | | |
| 23 | | tri-folding | face down | — | 570 | *4 | *5 |
| 24 | | of the | face up | other than the | 1250 | ejection of | *5 |
| | | overlapped | | below | | reversed sheets | |
| 25 | | sheets | | tab-sheet | 570 | *4 | *4 |
| 26 | | | both | — | 570 | *4 | *4 |
| | | | surfaces | | | | |
| 27 | | casing-in | face down | — | 570 | *4 | *5 |
| 28 | | of a sheet | both | — | 570 | *4 | *4 |
| | | bundle | surfaces | | | | |

*1: processing speed (mm/sec)
*2: setting the face of sheet to be ejected
*3: sheet ejection speed of apparatus A (mm/sec)
*4: straight conveyance
*5: reversal of a single sheet

TABLE 2

| | | | | | determination | | |
|---|---|---|---|---|---|---|---|
| | states | | | | | sheet reversing | |
| | | | | type or basis | | process in | sheet reversing |
| No. | *1 | post-finishing | *2 | weight of sheet | *3 | apparatus A | process in RU |
| 29 | 490 | non post- | face down | ultra-thick sheet | 490 | *4 | *5 |
| 30 | | finishing or | face up | ultra-thick sheet | 490 | *4 | *4 |
| 31 | | sheet shifting | both surfaces | ultra-thick sheet | 490 | *4 | *4 |
| 32 | | side-stitching | face down | ultra-thick sheet | 490 | *4 | *5 |
| 33 | | hole punching | face down | ultra-thick sheet | 490 | *4 | *5 |
| 34 | | multi-folding | face down | ultra-thick sheet | 490 | *4 | *5 |
| 35 | | | Face up | ultra-thick sheet | 490 | *4 | *4 |
| 36 | | | both surfaces | ultra-thick sheet | 490 | *4 | *4 |
| 37 | | saddle-stitching | both surfaces | ultra-thick sheet | 490 | *4 | *4 |
| 38 | | center folding | face down | ultra-thick sheet | 490 | *4 | *5 |
| 39 | | of the | both surfaces | ultra-thick sheet | 490 | *4 | *4 |
| | | overlapped sheet | | | | | |
| 40 | | tri-folding of | face down | ultra-thick sheet | 490 | *4 | *5 |
| 41 | | the overlapped | Face up | ultra-thick sheet | 490 | *4 | *4 |
| 42 | | sheets | both surfaces | ultra-thick sheet | 490 | *4 | *4 |
| 43 | | casing-in of a | face down | ultra-thick sheet | 490 | *4 | *5 |
| 44 | | sheet bundle | both surfaces | ultra-thick sheet | 490 | *4 | *4 |

*1: processing speed (mm/sec)
*2: setting the face of the sheet to be ejected
*3: sheet ejection speed of apparatus A (mm/sec)
*4: straight conveyance
*5: reversal of a single sheet

In Tables 1 and 2, the “conditions” column includes the various conditions which were detailed above. The “determination” column includes the sheet conveyance speed in sheet ejection section 5E of image forming apparatus A, discrimination between straight ejection route SH in the sheet ejection section of image forming apparatus A, or reversing ejection route HH of image forming apparatus A, and discrimination between second conveyance path P2 in intermediate conveyance unit B, or first conveyance path P1 in intermediate conveyance unit B.

The “processing speed” column shows the line speed of photoconductor 4A and fixing device 6 shown in FIG. 1. The “non post-finishing or sheet shifting” column in the “post-finishing” column means that no post-finishing is conducted on the sheet, or the sheet is ejected after the sheet shifting process. “Side-stitching” means that the plural sheets are stapled at one or two points on their single edge, but are not folded. “Hole punching” means that a sheet is hole-punched along one edge. “Multi-folding” means that the sheets are folded in various styles, such as tri-folding, and Z-folding. “Saddle-stitching ” means that the center of the sheet is stapled. “Center folding of the overlapped sheets” means that the plural sheets are overlapped and folded along their center. “Tri-folding of the overlapped sheets” means that the plural sheets are overlapped and they are folded into three parts. “Casing-in of a sheet bundle” means that plural sheets are bound to which a single coversheet is attached in U-shape to form a front cover and a back cover.

The “setting the face of sheet to be ejected” column means sheet ejection modes, such as a mode in which the sheet is ejected onto ejection tray 10 of post-finishing apparatus C in FIG. 1, while the surface carrying the image is turned over, which is a face-down ejection, another mode in which the sheet is ejected while the surface carrying the image is upward, which is a face-up ejection, and yet another mode in which the sheet is ejected carrying an image on both surfaces of the sheet.

The “type or basis weight of sheet” includes four groups, such as normal sheet, thick sheet, tab-sheet and ultra thick sheet.

The “sheet ejection speed of apparatus A (mm/sec)” column shows the linear conveyance speed of sheet ejection roller 50E in FIG. 1.

Additionally, when a sheet is ejected through reversing ejection route HH (see FIG. 1), ejection roller 50E operates at the sheet conveyance speed of 1,250 mm/sec to eject the sheet.

The “sheet reversing process in apparatus A” column means that the sheet is ejected through straight ejection route SH of image forming apparatus A, or the sheet is ejected through reversing ejection route HH of image forming apparatus A. “Straight conveyance” means that the sheet is ejected through straight ejection route SH, while “ejection of a reversed sheet” means that the sheet is ejected through reversing-ejection route SH. “Sheet reversing process in RU” means that the sheet is conveyed through first conveyance path P1 or second conveyance path P2, of intermediate conveyance unit B. “Straight conveyance” means that the sheet is conveyed through first conveyance path P1.

“Reversal of 3 overlapped sheets” “reversal of 2 overlapped sheets” and “reversal of a single sheet” means that conveyance is conducted through second conveyance path P2, whereby three sheets are overlapped and ejected as a unit, two sheets are overlapped and ejected as a unit, and a single sheet is ejected, respectively.

All data on column “determination” corresponding to Nos. 1-44, of Tables 1 and 2, prepared for the processes to be conducted in intermediate conveyance unit B, are stored in memory device MR1 of image forming apparatus A and memory device MR2 of intermediate conveyance unit B. Main control section MC determines “sheet ejection speed of apparatus A (mm/sec)” and “sheet reversing process in apparatus A” both shown in the “determination” column, while referring to Tables 1 and 2, stored in memory device MR1, based on the various items of the “states” column of Tables 1 and 2.

Further, RU control section RUC determines “sheet reversing process in RU” shown in Tables 1 and 2, while referring to Tables 1 and 2 which are stored in memory device MR2, based on information relating to the “states” column of Tables 1 and 2, sent from main control section MC.

In No. 1, for example, image formation is conducted at process speed 570 mm/sec on normal thickness sheets. No post-finishing is conducted or shift processing is conducted, the sheet is ejected at a line speed of 570 mm/sec on the ejection section of image forming apparatus A, and the sheet is straightly ejected at the ejection section of image forming apparatus A, after which three sheets are stored in vertical stacking section B1 of intermediate conveyance unit B, whereby said three sheets are sent in a unit to post-finishing apparatus C, then they are ejected in the face-down mode onto ejection tray 10 of post-finishing apparatus C.

The number of processed sheets during a unit time in post-finishing apparatus C is less than that in image forming apparatus A. However, since three sheets in a unit are conveyed in intermediate conveyance unit B, the difference between the sheet processing numbers is absorbed by intermediate conveyance unit B, so that image forming procedure can be conducted without interruption.

Further, in No. 1, though straight sheet ejection is conducted in image forming apparatus A, the sheet is reversed in intermediate conveyance unit B, so that the sheet is ejected onto ejection tray 10 to be stored in the face-down mode.

No. 4 will be detailed as another example.

Image formation is conducted on normal thickness sheet S at a processing speed of 570 mm/sec, the sheet is reversed by reversing-ejection route HH, and the sheet ejection speed on image forming apparatus A is 1,250 mm/sec.

In intermediate conveyance unit B, sheet S is conveyed through vertical stacking section B1. Until sheet S enters vertical stacking section B1, the sheet is conveyed at 1,250 mm/sec, which is the sheet conveyance speed of image forming apparatus A.

After two or three sheets S are stacked in vertical stacking section B1, said sheets S are conveyed to post-finishing apparatus C. In order to carry out sheets S from vertical stacking section B1, a sheet conveyance speed 1,000 mm/sec is used, which is the sheet conveyance speed of post-finishing apparatus C.

In the case of the ultra-thick sheet (the basis weight is greater than 210 g/m²) in Table 2, in order to sufficiently conduct the fixing operation, the sheet conveyance speed in image forming apparatus A is uniformly set at 490 mm/sec.

### <Post-Finishing Apparatus>

Various post-finishing apparatuses will be detailed below, which are hole punching—sheet folding machine FS1, side-stitch binding machine FS2, saddle-stitch binding machine FS3, large capacity sheet stacking machine (hereinafter referred to as “large capacity stacker”) FS4, and sheet casing-in machine FS5.

### <Hole Punching—Sheet Folding Machine>

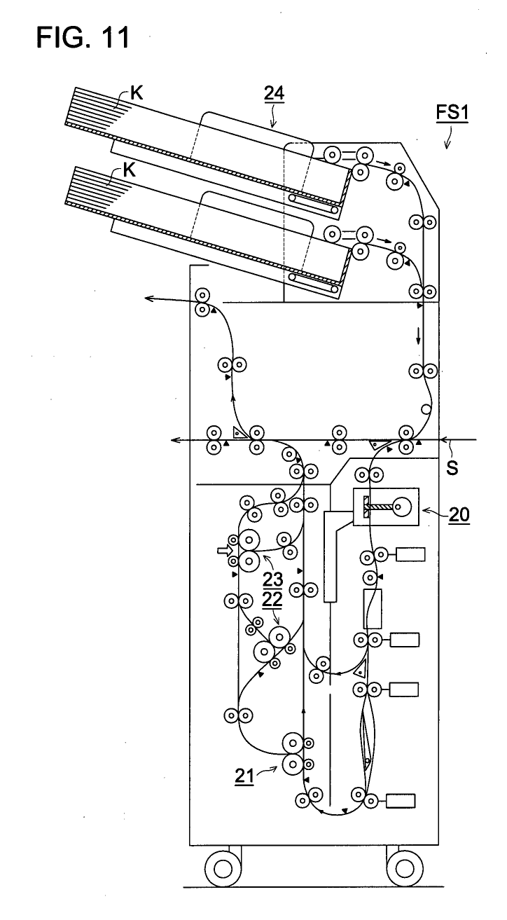

FIG. 11 is a total structural view of hole punching—sheet folding machine FS1, serving as the post-finishing apparatus.

Hole punching—sheet folding apparatus FS1, structured of hole punching section 20, first folding section 21, second folding section 22, third folding section 23 and coversheet supplying section 24, conducts hole-punching and various folding operations onto sheets S carrying the image, or coversheet K.

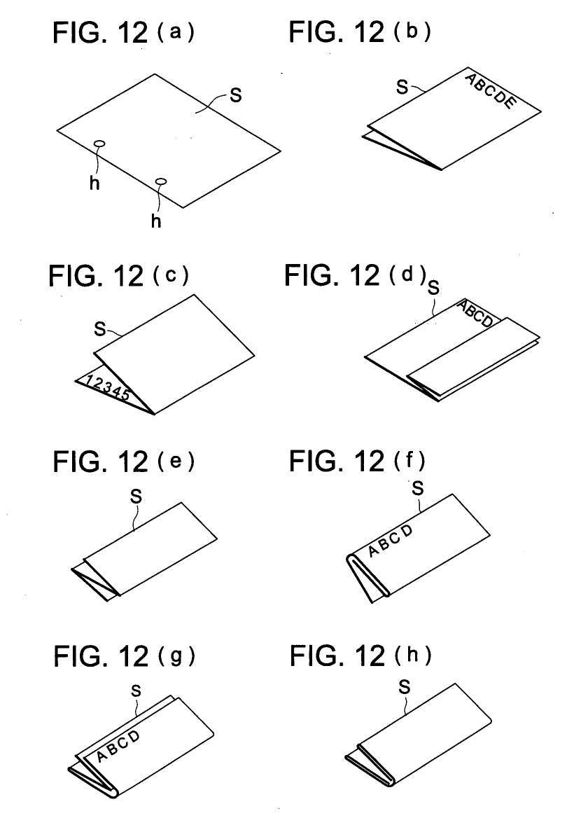

FIGS. 12(a)-12(h) are perspective views of sheets S having punched holes and folded in one of various configurations.

FIG. 12(a) shows sheet S having two holes punched by hole punching section 20. FIG. 12(b) shows sheet S which is center-folded by first folding section 21, with its image carrying surface facing out. FIG. 12(c) shows sheet S which is center-folded by first folding section 21, with its image carrying surface facing in. FIG. 12(d) shows sheet S which is Z-folded by first folding section 21 and third folding section 23, with its image carrying surface facing in. FIG. 12(e) shows sheet S which is Zigzag-folded by first folding section 21 and second folding section 22, with its image carrying surface facing out. FIG. 12(f) shows sheet S which is letter-folded by first folding section 21 and second folding section 22. FIG. 12(g) shows sheet S which is double-parallel-folded by first folding section 21 and second folding section 22. FIG. 12(h) shows sheet S which is folded in four by first folding section 21, second folding section 22 and third folding section 23.

Hole punching—sheet folding apparatus FS1 incorporates two-stage coversheet supplying device 24, in which each stage stores 500 sheets of coversheets K.

### <Side-Stitch Binding Machine>

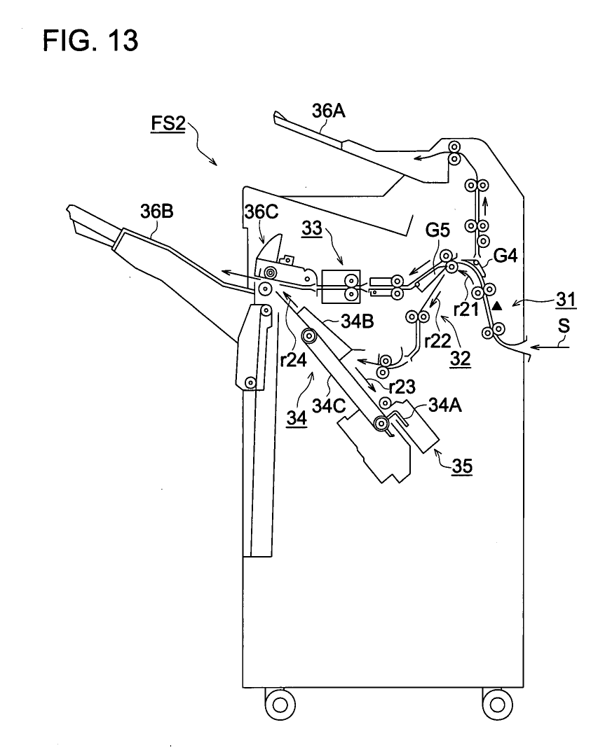

FIG. 13 is a total structural view of side-stitch binding machine FS2, serving as the post-finishing apparatus.

Side-stitch binding machine FS2 is structured of sheet entrance conveyance section 31, intermediate conveyance section 32, shift processing section 33, stacker unit 34, stapler unit 35 and a sheet ejection section. The sheet ejection section is structured of sub-tray 36A being on the highest position of FS2, and elevating main tray 36B being on the left side in FIG. 13.

Sheet S, conveyed through entrance conveyance section 31, is directed by conveyance route switching sections G4 and G5, to one of three routes, which are a simple ejection route directed toward sub-tray 36A, a straight ejection route directing to elevating main tray 36B, and a side-stitching-ejection route directed toward the side-stitching section.

Sheet S, on which side-stitch binding operation is to be conducted, passes through sheet conveyance route r21 arranged below conveyance route switching sections G4, and next passes through sheet conveyance route r22 mounted below conveyance route switching sections G5, then slides on a slope of stacker unit 34, after which the leading edge of sheet S stops at a stopping surface of side-stitching stopper 34A. Width alignment section 34B aligns the edges of sheets S stacked on stacker unit 34.

At this stopped position, when a predetermined number of sheets S are stacked and aligned, sheets S are stapled by stapler 35, structured of a stapling mechanism and a staple receiving mechanism.

Looped ejection belt 34C, mounted on stacker unit 34, conveys stapled sheets S upward at an angle, where stapled sheets S is supported by ejection unit 36C and is conveyed onto vertically elevating main tray 36B.

Side-stitch binding machine FS2 can stitch a maximum of 100 sheets to produce a booklet.

### <Saddle-Stitch Binding Machine>

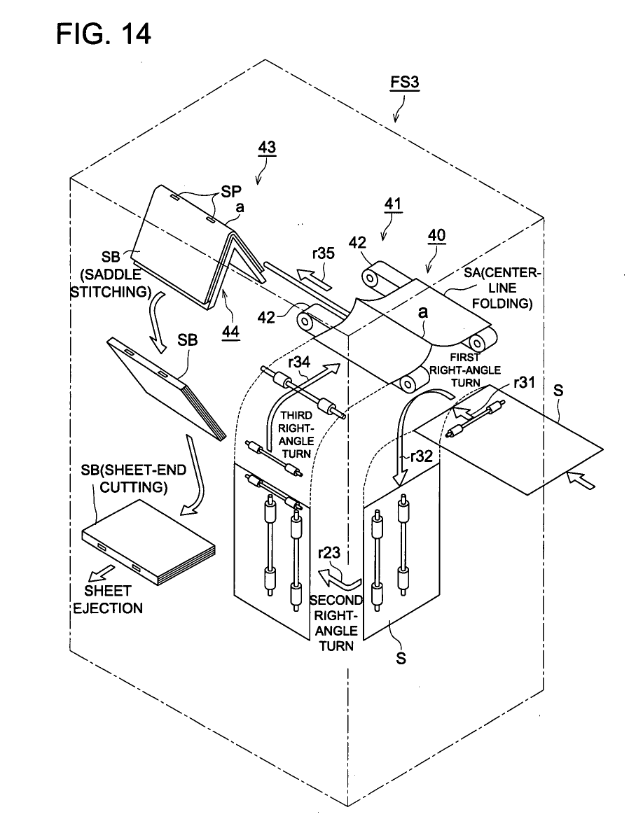

FIG. 14 is a schematic view showing the center folding process and sheet conveyance of a saddle-stitching process conducted by saddle-stitch binding machine FS3, serving as the post-finishing apparatus.

Sheet S, introduced into saddle-stitch binding machine FS3, is conveyed downward from nearly horizontal conveyance route r31 to nearly vertical conveyance route r32, where it is turned at right angle and then supported (being the first right-angle-turn). Next, supported sheet S is again turned at right angle and conveyed in conveyance route r23, where sheet S stands vertically in conveyance route r33, after which sheet S temporarily stops at a predetermine position (being the second right-angle-turn). Next, after sheet S is vertically lifted up by paired conveyance rollers, sheet S is once again turned at right angle, and stops at a predetermined position (being the third right-angle-turn) on conveyance route r34. After the position of sheet S is determined at this stopped position, sheet S is center-folded by folding section 40.

A single sheet S or plural sheets S, stopped at folding section 40, is/are nipped by folding rollers rotating in opposite directions to each other, and a straightly movable folding plate, whereby center folding is conducted on sheet S, that is, folded crease “a” is generated on the center of sheet S, being across the width direction of sheet S.

Folded sheet SA is conveyed to conveyance route r35, which is parallel to folding crease “a”, by conveyance belt 42 of conveyance section 41, and is carried in saddle-stitching section 43.

Accordingly, folding section 40 can fold a single sheet S or a few sheets S at the center, and generate sharply folded crease “a”. Folding section 40 continuously sends folded sheet SA to saddle-stitching section 43, where high quality booklets SB with sharply folded creases “a” will be produced in the following steps.

Folded sheet SA, having been center-folded by folding section 40, is conveyed through conveyance route r35, and is placed on stacker 44 of saddle-stitching section 43. A specified number of following folded sheets SA are also conveyed through conveyance route r35, and are placed on stacker 44.

A specific plurality of folded sheets SA, placed on stacker 44, are precisely positioned by width alignment section.

Two sets of separable stitching devices, each structured of a stapling mechanism mounted above stacker 44, and a staple receiving section mounted within stacker 44, are arranged parallel to folding crease “a”. When the saddle-stitch binding operation is set on the operation section, the staple receiving section rises and the saddle-stitch binding operation is conducted. That is, two sets of stitching devices strike staples SP at two symmetrical positions with respect to the center of folded crease “a” of folded sheets SA placed on stacker 44.

Since saddle-stitching has been conducted onto folded sheets SA by saddle-stitching section 43, booklet SB is produced. After booklet SB is taken out from stacker 44, both ends of booklet SB are cut off by a sheet-end cutter so that booklet SB is fixed up in good trim, then booklet SB is ejected to ejection tray 10.

Via saddle-stitch binding machine FS3, sheet S is center-folded, and a maximum of 30 sheets S are saddle-stitched, which become booklet SB, including up to 120 pages.

### <Large-Capacity Sheet Stacker>

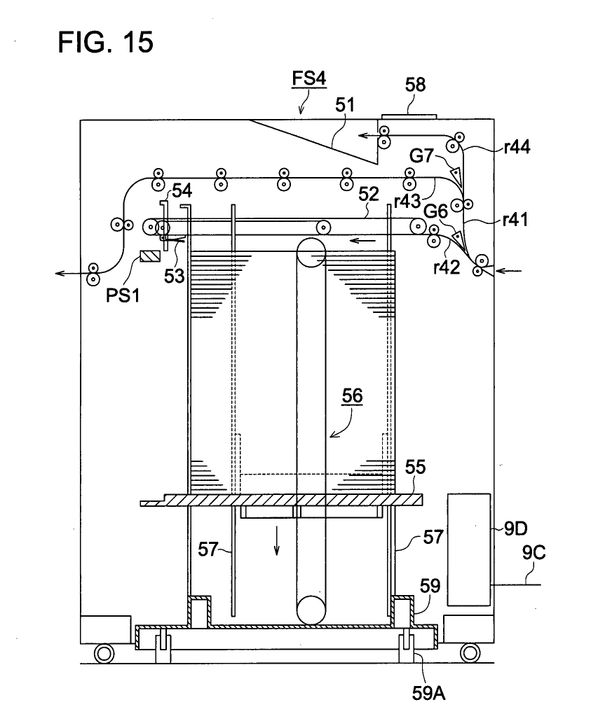

FIG. 15 is a cross-sectional front view of large-capacity sheet stacker FS4.

Sheet S, ejected from image forming apparatus A or post-finishing apparatus C, is introduced to the entrance section of large-capacity sheet stacker FS4, and is conveyed to either sheet conveyance route r41 mounted above conveyance route switching section G6, or sheet conveyance route r42 mounted below conveyance route switching section G6. Sheet S, directed to sheet conveyance route r41, is conveyed to either sheet conveyance route r44 mounted above conveyance route switching section G7, or sheet conveyance route r43 mounted below conveyance route switching section G7.

Sheet S, entering sheet conveyance route r44, is stacked onto sub-tray 51 which is formed at the upper section of large capacity stacker FS4. Sheet S, conveyed to sheet conveyance route r43, is ejected to the exterior of large capacity stacker FS4, or is sent to another large capacity stacker.

Sheet S, entering sheet conveyance route r42, is gripped by gripper 53, mounted on rotatable belt 52, at the leading edge of sheet S, and is conveyed toward the left on FIG. 15.

Sheet leading-edge regulating member 54, provided near the left end of rotatable belt 52, is shifted to a predetermined position which corresponds to the size of sheet S to be introduced to large capacity stacker FS4, and regulates the leading edge of sheet S.

When the leading edge of sheet S contacts sheet leading edge regulating member 54, gripper 53 releases sheet S so that sheet S drops down onto sheet stacking plate 55.

Sheet stacking plate 55 is driven by vertical driving section 56 structured of elevating members, such as a motor, a belt and a wire, and is vertically driven along guide member 57.

When sheet S, stored in large capacity stacker FS4, is to be picked up, the operator designates opening of large capacity stacker FS4 via operating display section 8 of image forming apparatus A or operating display section 58 of large capacity stacker FS4. Via this configuration, vertical driving section 56 downwardly drives sheet stacking plate 55.

At the lower section of large-capacity stacker FS4, sheet carrying wagon 59, having wheels 59A, is movably arranged. Sheet stacking plate 55 is lowered until it comes into contact with the top surface of sheet carrying wagon 59, and the wire of vertical driving section 56 is further driven so that sheet stacking plate 55 is released, and the wire is stopped.

The operator then opens a front door of large capacity stacker FS4, and pulls sheet carrying wagon 59 by hand or electric operation, after which sheets S, stacked on sheet stacking plate 55, which is placed on sheet carrying wagon 59, can be easily picked up by the operator from large capacity stacker FS4.

Large-capacity stacker FS4 can stack a maximum of 5,000 sheets on sheet stacking plate 55, and obviously, if two large-capacity stackers FS4 are combined, they can stack a maximum of 10,000 sheets.

When the maximum number of sheets S are stacked on sheet stacking plate 55 of large-capacity stacker FS4, (that is, 5,000 sheets are stacked), sensor PS1 detects that sheets are stacked to the maximum stacking height. Control section 9D switches the conveyance route from conveyance route r42 to conveyance routes r41 and r43, and controls conveyance of sheet S which was ejected from image forming apparatus A, whereby sheet S can be sent to a large-capacity stacker which is prepared on a subsequent stage.

In addition, sheets S, ejected from image forming apparatus A, can be grouped and stacked in large capacity stackers FS4, based on the size of sheet, the basis weight of a sheet, and the contents of the documents.

### <Sheet Casing-in Machine>

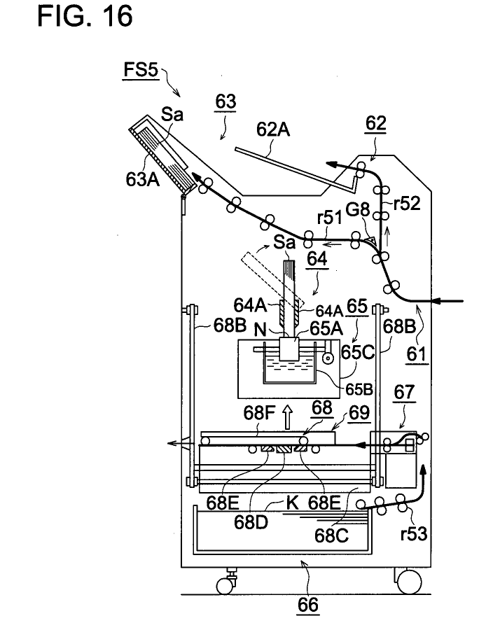

FIG. 16 shows a front sectional view of sheet casing-in machine FS5, serving as the post-finishing apparatus.

Sheet casing-in machine FS5 is structured of sheet introduction section 61, sheet ejection section 62, sheet bundle storing section 63, sheets bundle conveying section 64, adhesive coating section 65, coversheet supplying section 66, coversheet cutting section 67, coversheet adhering section (being a casing-in section) 68, and alignment section 69. Each section cascades vertically in sheet casing-in machine FS5.

After sheet S is introduced into sheet introduction section 61, sheet S is directed by conveyance route switching section G8, to either sheet ejection section 62 or sheet bundle storing section 63.

If sheet S is set to be conveyed to sheet ejection section 62, conveyance route switching section G8 closes sheet conveyance route r51, directing to sheet bundle conveyance section 64, and opens sheet conveyance route r52 directing toward sheet ejection section 62. Sheet S, going upward through conveyance route r52, is stored on unmovable sheet ejection plate 62A, on which a maximum of 200 sheets S can be stored.

Sheet S, which is directed toward sheet conveyance route r51 by conveyance route switching section G8, is subsequently stacked on a predetermined position of sheet bundle storing section 63. After sheets S are aligned in the conveying direction and in the sheet width direction, sheet bundle Sa is formed, having a predetermined number of sheets.

Sheet bundle Sa, placed on sheet stacking plate 63A of sheet bundle storing section 63, are conveyed downward at an oblique angle, after which sheet bundle Sa is nipped by nipping section 64A of sheet bundle conveyance section 64, and sheet bundle Sa, having been nipped, is rotated and stopped at a predetermined position so that a surface (to be the spine) of sheet bundle Sa, to be coated with adhesive, faces downward.

Adhesive coating section 65 includes adhesive coating roller 65A, adhesive container 65B and moving section 65C. Moving section 65C, supporting adhesive container 65B, is capable of moving from an initial position at the rear of sheet casing-in machine FS5, to a position where adhesive coating is to be conducted, being the front side of sheet casing-in machine FS5.

Cover sheet K, stored in coversheet supplying section 66, is conveyed through coversheet conveyance route r53 and coversheet cutting section 67 and reaches coversheet adhering section 68, where the trailing edge of coversheet K is cut by coversheet cutting section 67 so that coversheet K is trimmed at a predetermined length. The length of trimmed coversheet K is two lengths in the conveyance direction of sheet S adding the width of the spine of sheet bundle Sa.

Coversheet adhering section 68 conveys trimmed coversheet K to a predetermine position, where alignment section 69 aligns trimmed coversheet K along the width direction. Coversheet adhering section 68 allows paired elevating sections 68B to rise elevating body 68C. At the risen position, the center of sheet K, which is placed on pressure applying member 68D, is pressure-contact with adhesive coated surface N of sheet bundle Sa to be adhered.

Pressure applying member 68D facing the spine of sheet bundle Sa is lowered, and paired folding members 68E, symmetrically arranged at the top section of coversheet adhering section 68, move so that coversheet K is folded at the edges of adhesive coated surface N of sheet bundle Sa. That is, the front and rear faces and the spine of sheet bundle Sa are covered with coversheet K.

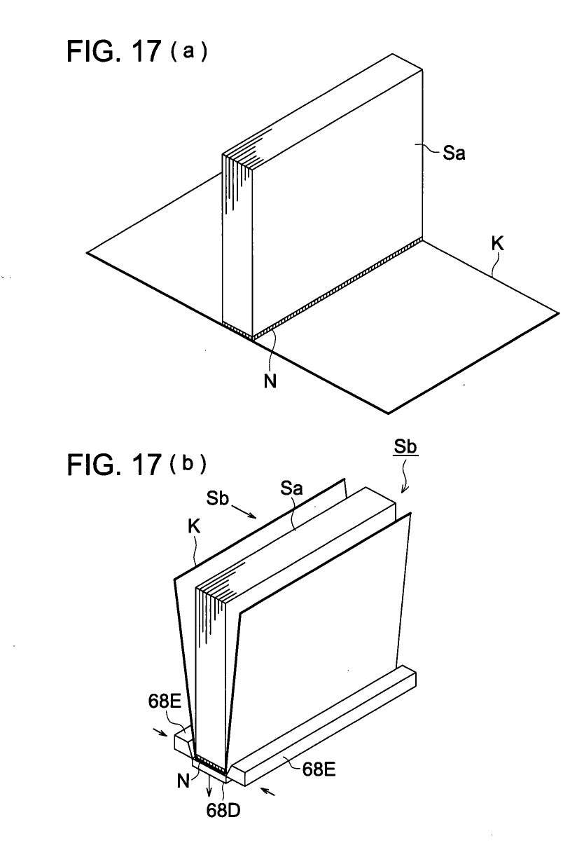

FIG. 17(a) is a perspective view of the sheet bundle which is adhered to coversheet K, while FIG. 17(b) is a perspective view of booklet Sb (being a finished booklet) which is produced of sheet bundle Sa, covered with coversheet K.

In FIG. 16, after coversheet K is folded, coversheet adhering section 68 is driven downward by paired elevating sections 68B. Then, ejection belt 68F, which has retracted toward the outside in the width direction of coversheet K, with the retraction of alignment member 69, moves in the width direction of booklet Sb, to the inside under booklet Sb, and stops. Subsequently, paired nipping section 64A release booklet Sb, and booklet Sb is lowered so that the spine of booklet Sb comes in contact with the surface of ejection belt 68F, where booklet Sb stops. Rotatable ejection belt 68F ejects booklet Sb, which now carries U-shaped cover of coversheet K, outside sheet casing-in machine FS5.

Sheet casing-in machine FS5 can produce booklets Sb including a maximum of 100 sheets S.

### <Image Forming System>

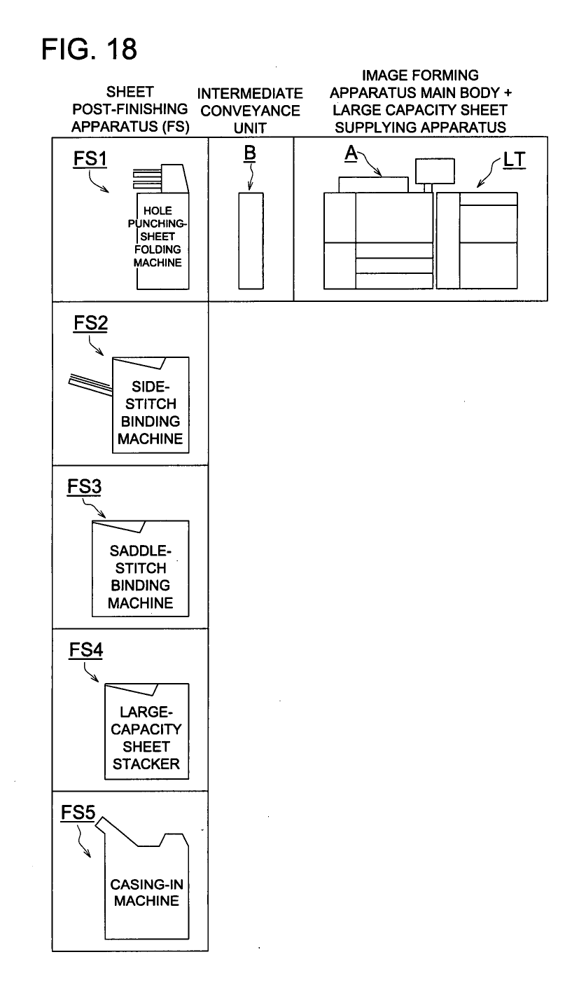

FIG. 18 is a conceptual diagram of the image forming system, structured of the image forming apparatus, intermediate conveyance unit and the post-finishing apparatus.

Hole punching—sheet folding machine FS1, side-stitch binding machine FS2, saddle-stitch binding machine FS3, large capacity-stacker FS4 and sheet casing-in machine FS5 can be listed as the post-finishing apparatus. Since these machines are listed only as examples, various post-finishing apparatuses other than the above examples can be listed in the image forming system.

These post-finishing apparatuses FS1-FS5 are connected to the sheet ejection side of intermediate conveyance unit B so that an efficient image forming system is structured.

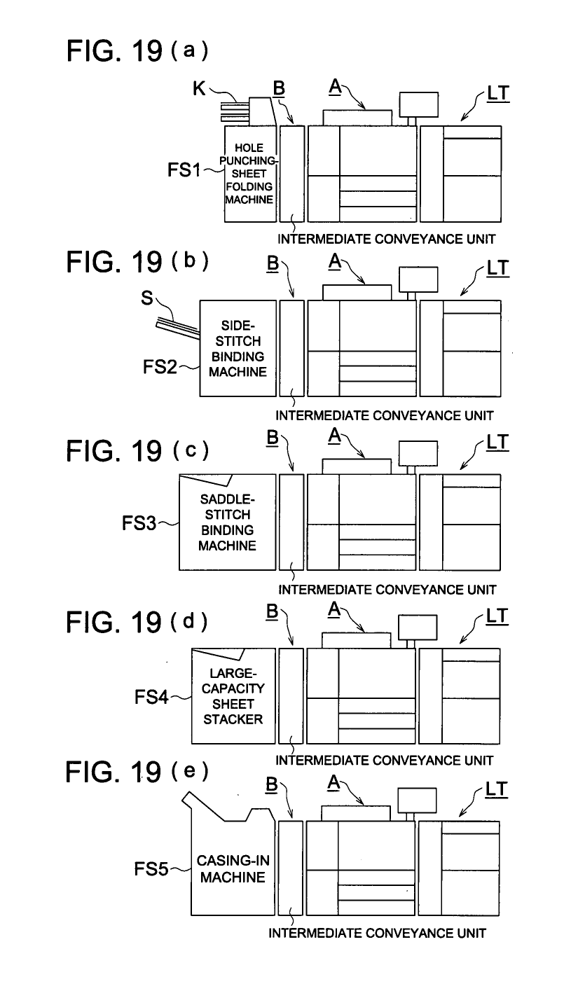

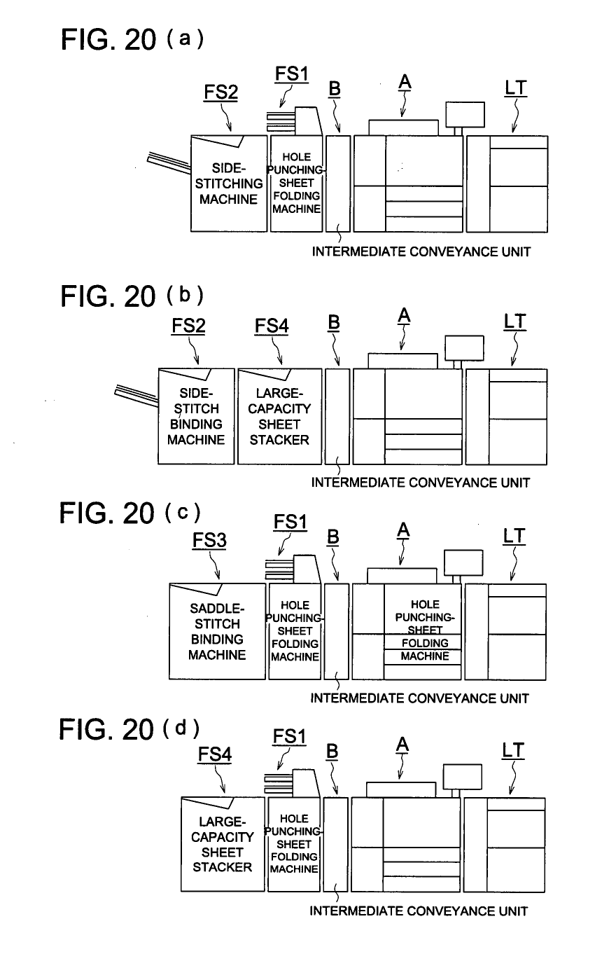

FIGS. 19 and 20 show the image forming system including any one or two post-finishing apparatuses FS1-FS5 shown in FIG. 18. FIG. 19 shows an example in which a single post-finishing apparatus is combined to the sheet ejection side of intermediate conveyance unit B, while FIG. 20 shows an example in which two post-finishing apparatuses are connected to intermediate conveyance unit B.

Controls of the image forming system shown in FIGS. 19 and 20 will be detailed, while also referring to FIG. 10.

If any of post-finishing apparatuses FS1-FS5 is combined to intermediate unit B, main control section MC determines the type of connected post-finishing apparatus, and sends information of the post-finishing operation, which is capable of being processed by the connected post-finishing apparatus, to operation section OP and communication section TC.

Operation section OP and communication section TC receive said information and display it, or send it to the appropriate external devices.

For image formation, when the operator selects the desired post-finishing functions from among the displayed post-finishing functions, setting information is inputted into main control section MC via operation section OP or communication section TC. Further, various information, such as the type and thickness of the sheet, and the sheet ejection mode, are inputted to main control section MC via operation section OP or communication section TC.

Based on inputted information, main control section MC sends necessary information to RU control section RUC and post-finishing control section FSC, and subsequently selects a sheet ejection mode (modes using straight ejection route SH or reversing ejection route HH) in sheet ejection section 5E, while referring to memory device MR1.

Based on information sent from main control section MC, RU control section RUC determines whether to use the first conveyance route or the second conveyance route, while referring to information stored in memory device MR2. Further, RU control section RUC determines the number of sheets to be stacked as a unit in vertical stacking section B1.

Control section FSC of post-finishing apparatus C conducts the designated post-finishing process, based on information sent from main control section MC.

As described above, it is possible for the image forming system to store the information shown in Tables 1 and 2 in memory device MR1. In this case, main control section MC determines total information in Tables 1 and 2, whereby main control section MC gives instruction to RU control section RUC, concerning whether to use the first conveyance route or the second conveyance route, and instruction concerning the number of sheets to be stacked as one unit in vertical stacking section B1. RU control section RUC receives said instructions, and selects either the first conveyance route or the second conveyance route.

Based on the present invention, the second conveyance route is provided, by which plural sheets are stacked in the intermediate conveyance unit, then, one unit of said plural sheets can be ejected to the post-finishing apparatus. Further, the first conveyance route is provided, by which after a single sheet is received from the image forming apparatus, the single sheet is ejected to the post-finishing apparatus. These sheet conveyance routes can be selected based on the various conditions. Accordingly, the present invention capitalizes on the high forming speed of the image forming apparatus, and meets the various demands to the post-finishing apparatus, while securing stable conveyance of the sheet.

What is claimed is:

1. An image forming system, comprising:
an image forming apparatus to form an image on a sheet;
a post-finishing apparatus to conduct a post-finishing operation on the sheet carrying the formed image;
an intermediate conveyance unit, provided between the image forming apparatus and the post-finishing apparatus, to convey the sheet ejected from the image forming apparatus to the post-finishing apparatus;
wherein the intermediate conveyance unit includes
a first conveyance route which receives the sheet one by one from the image forming apparatus and ejects the sheet one by one to the post-finishing apparatus;
a second conveyance route which receives the sheet one by one from the image forming apparatus and overlaps the sheets as a set of plural sheets to be ejected to the post processing apparatus, and
a control section which selects either the first conveyance route or the second conveyance route based on an image forming condition.

2. The image forming system of claim 1,
wherein the image forming condition is a type of the post-finishing process in the post-finishing apparatus.

3. The image forming system of claim 1, wherein the image forming apparatus has an image forming mode in which processing number of the sheet in a unit time is greater than the processing number of the sheet on the post-finishing apparatus in a unit time, and the control section selects the second conveyance path in the image forming mode.

4. The image forming system of claim 1, wherein the post-finishing apparatus conveys the sheet at a sheet conveyance speed which differs from a sheet conveyance speed in the image forming apparatus, and after the intermediate conveyance unit receives the sheet at the sheet conveyance speed of the image forming apparatus, changes the sheet conveyance speed to be the same as the sheet conveyance speed of the post-finishing apparatus, and ejects the sheet to the post-finishing apparatus.

5. The image forming system of claim 1, wherein the second conveyance route serves as a route to reverse the sheet.

6. The image forming system of claim 1, wherein the image forming apparatus conveys the sheet at a sheet conveyance speed corresponding to at least any one of the type or thickness of the sheet, and ejects the sheet to the intermediate conveyance unit.

7. The image forming system of claim 1, further comprising a memory section which stores a table for selecting either the first conveyance route or the second conveyance route corresponding to the image forming condition.

8. The image forming system of claim 1, wherein the control section selects either the first conveyance route or the second conveyance route based on the type of the post-finishing process.

9. The image forming system of claim 1, wherein the control section determines a number of the sheet to be stacked in the second conveyance route to be one or more sheets.

10. The image forming apparatus of claim 1, wherein the intermediate conveyance unit includes a width directional alignment member which aligns the sheet stored in the second conveyance route toward a width direction which is perpendicular to the conveyance direction of the sheet.

11. The image forming apparatus of claim 1, wherein the intermediate conveyance unit includes a vertical alignment member which aligns the sheets stored in the second conveyance route toward a vertical direction which is parallel to the conveyance direction of the sheet.

12. The image forming apparatus of claim 1, wherein the intermediate conveyance unit includes a stopping member which is mounted in a horizontal direction in the second conveyance route and on which the sheet drops by its own weight and a leading edge of the sheet stops.

13. The image forming system of claim 1, wherein the post-finishing process is a process to punch a hole through two or more overlapped sheets simultaneously.

14. The image forming system of claim 1, wherein the post-finishing process is a process to fold two or more overlapped sheets.

15. The image forming system of claim 1, wherein the post-finishing process is a process to conduct a stitching operation at an adjacent portion of one edge of a sheet bundle including plural sheets.

16. The image forming system of claim 1, wherein the post-finishing process is an adhesive coating book binding process which coats a spine of the sheet bundle including the plural sheets with an adhesive.

17. An intermediate conveyance unit which conveys a sheet ejected from an image forming apparatus and conveys the sheet to a post-finishing apparatus, comprising,
a first conveyance route which receives a sheet one by one from the image forming apparatus and ejects the sheet one by one to the post-finishing apparatus,
a second conveyance route which receives a sheet one by one from the image forming apparatus and stacks the sheets as a set of plural sheets to eject to the post processing apparatus, and
a control section which selects either the first conveyance route or the second conveyance route based on an image forming condition.

18. The intermediate conveyance unit of claim 17, wherein the control section selects either the first conveyance route or the second conveyance route based on a type of the post-finishing process.

19. The intermediate conveyance unit of claim 17, wherein the second conveyance route is a conveyance route which reverses the sheet.

20. The intermediate conveyance unit of claim 17, wherein after the sheet is conveyed at the sheet conveyance speed of the image forming apparatus, the control section changes the sheet conveyance speed to the sheet conveyance speed of the post-finishing apparatus to convey the sheet.
